(19) United States
(12) Patent Application Publication
(10) Pub. No.: US 2022/0158857 A1
(43) Pub. Date: May 19, 2022

(54) SYSTEMS AND METHODS FOR INFRASTRUCTURE MANAGEMENT SYSTEM BASED POWER SOURCING EQUIPMENT POWER ALLOCATION

(71) Applicant: CommScope Technologies LLC, Hickory, NC (US)

(72) Inventors: Michael Gregory German, Secaucus, NJ (US); Matias Peluffo, Singapore (SG); Niall McAndrew, Dublin (IE); Jason Bautista, Mayer, MN (US); Kristof Johan Jeuris, Leuven (BE)

(73) Assignee: CommScope Technologies LLC, Hickory, NC (US)

(21) Appl. No.: 17/436,731

(22) PCT Filed: Feb. 21, 2020
(86) PCT No.: PCT/US2020/019224

§ 371 Date: Sep. 7, 2021

Related U.S. Application Data
(60) Provisional application No. 62/821,034, filed on Mar. 20, 2019.

(51) Int. Cl. H04L 12/10

(52) U.S. Cl. CPC H04L 12/10

(57) ABSTRACT

In one embodiment, a system manager for a network management system comprises: a PSE power management function implemented by a processor; and a cabling information database; wherein the PSE power management function is configured to couple to a power sourcing network switch via a network; wherein the PSE power management function, in response to a request to allocate power from the switch to a network powered device: determines a length of cabling for instances of network cabling that couples the network switch to the network powered device based on network cable length information stored in the cabling information database; determines a power loss based on the length of cabling; and transmits a power allocation command to the network switch to allocate a power level to a network port coupled to the network powered device based on the power loss and a power class of the network powered device.

### CROSS-REFERENCE FOR RELATED APPLICAIONS

This International Patent Application claims priority to, and the benefit of, U.S. Provisional Patent Application No. 62/821,034, titled “SYSTEMS AND METHODS FOR INFRASTRUCTURE MANAGEMENT SYSTEM BASED POWER SOURCING EQUIPMENT POWER ALLOCATION” filed on 20 Mar. 2019, which is incorporated by references in its entirety.

### BACKGROUND

In typical Power-over-Ethernet (PoE) implementations, when a powered end device is connected to a PoE switch, a negotiation is performed to determine the amount of power the powered end device requires from the PoE switch. By default, that determination is a function of the PoE class of the powered end device, and also based on predefine maximum cable length of the cable connecting the powered end device to the PoE switch (which by current PoE standards is 100 meters). Due to voltage drop that occurs over the length of the cable, the actual power received by the powered end device will be less than the power delivered from the PoE switch port. By assuming that a powered end device is coupled to the PoE switch port by a cable having the maximum cable length, and reserving power at the PoE switch port based on that worst case cable length scenario, the PoE switch can be sure it will always be able to meet the power needs of the powered end device. However, in many cases, the powered end device will be coupled to the PoE switch port by a cable much less than the predefine maximum permitted cable length so that the voltage drop between the PoE switch and the end user device will be less than under the worst case cable length scenario. As a result, the PoE switch will be reserving from is power budget more power for that powered end device than will ever be necessary to meet the power needs of the powered end device. Recent changes in PoE standards allow PoE switches to be more efficient in how they manage PoE budgets by taking into consideration the actual amount of power loss that occurs on the cable used to connect a Power switch port to a powered end device. In particular, the new IEEE 802.3bt standard includes an optional “Autoclass” feature which will initially reserve the full worst case scenario PoE budget when a powered end device is connected, but then gradually reduces the PoE allocated to the port serving that device until a nominal level is reached that is the sum of power actually demanded by the device plus the power actually lost due to the length of cable. The balance of the allocation is returned to the PoE switch budget for allocation to other ports. However, PoE switches that have been produced under prior standards, or whose manufacturers select not to implement the optional Autoclass feature under IEEE 802.3bt in their product, cannot take advantage of this feature and must fall back on allocating power to PoE switch ports purely based on the PoE class of the powered end device.

### SUMMARY

A system manager for a network management system, the system manager comprising: a processor coupled to a memory; a power sourcing equipment (PSE) power management function implemented by the processor; and a cabling information database; wherein the PSE power management function is configured to communicatively couple to a power sourcing network switch via a network; wherein the PSE power management function, in response to receiving a request to allocate power from the power sourcing network switch to a network powered device: determines a length of cabling for one or more instances of network cabling that couples the power sourcing network switch to the network powered device based on network cable length information stored in the cabling information database; determines a power loss based on the length of cabling; and transmits a power allocation command to the power sourcing network switch to allocate a power level to a network port coupled to the network powered device based on the power loss and a power class of the network powered device.

### DRAWINGS

Embodiments of the present disclosure can be more easily understood and further advantages and uses thereof more readily apparent, when considered in view of the description of the preferred embodiments and the following figures in which:

FIG. 1 is block diagram illustrating an example embodiment of a network management system configured to implement power budget management for power sourcing equipment.

FIG. 2 is block diagram illustrating an example embodiment of a power sourcing network switch and system manger for a network management system.

FIG. 3 is a diagram illustrating an example embodiment of a network cabling path between power sourcing equipment and a network powered device.

FIG. 4 is a flow chart illustrating an example method embodiment.

In accordance with common practice, the various described features are not drawn to scale but are drawn to emphasize features relevant to the present disclosure. Reference characters denote like elements throughout figures and text.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments may be utilized, and that logical, mechanical and electrical changes may be made without departing from the scope of the present disclosure. The following detailed description is, therefore, not to be taken in a limiting sense.

One or more of the example embodiments disclosed herein provide systems and methods for infrastructure management system based power sourcing equipment power budgeting. More specifically, in some embodiments, a network system manager implements a power sourcing equipment power management function that is activated when a new network powered device is coupled to a port of a power sourcing equipment, such as a power sourcing network switch, and determines an amount of power to allocated to that port from the current available power budget of the power sourcing equipment. Moreover, this determination takes into consideration both the power class of the powered device being connected, and information about the actual length of cabling that exists between the power sourcing equipment and the powered device being connected per cable length data accessible to the the network system manager. Power loss calculations may then be performed to determine the power to be supplied at the power sourcing equipment port in order for the powered device to receive its rated power needs. The power sourcing equipment power management function may then communicate with the power sourcing equipment (via a management interface, for example) to instruct the power sourcing equipment how much power to allocate to that port. In this manner, the power sourcing equipment is able to more efficiently allocate its available power budget by considering actual cable lengths, rather than allocating based on worst case scenario assumed cable lengths. In other embodiments, the cabling length information may be utilized by the power sourcing equipment power management function to authorize extended power allocations to power sourcing equipment port. The extended power allocations may be used to permit the power sourcing network switch to deliver, at the powered device, a greater amount of power than would normally be permitted given the powered device's power class under worst case scenario assumed cable lengths. Each of these embodiments, and others, are discussed in the disclosure below.

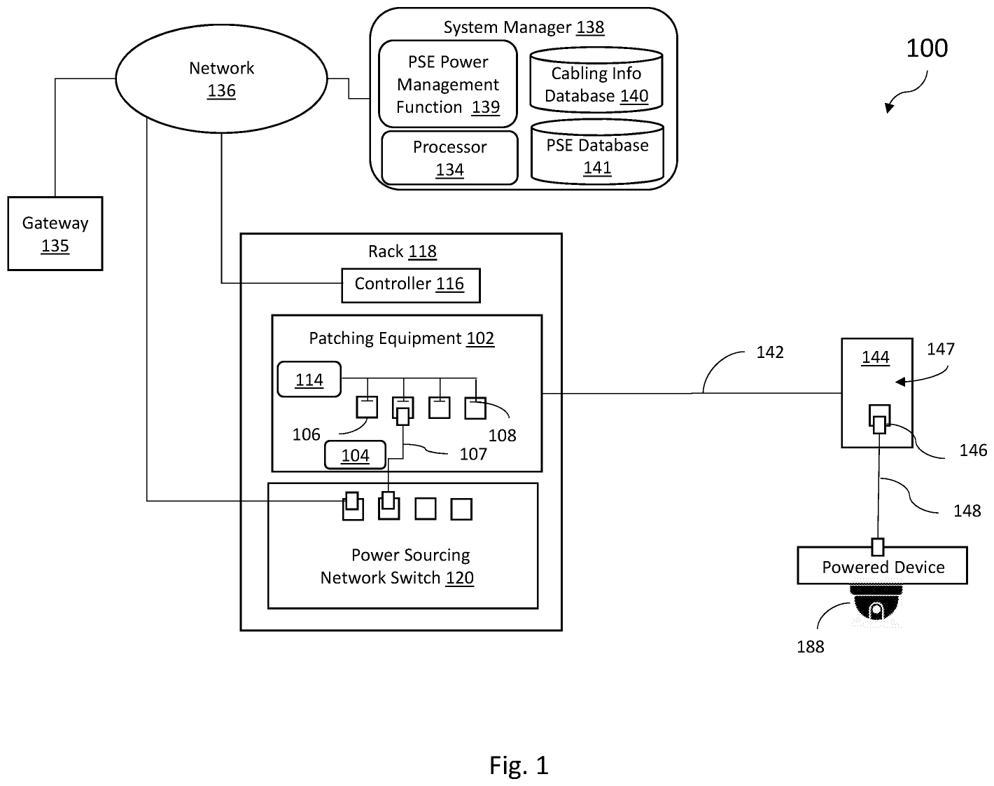

FIG. 1 is a block diagram of one exemplary embodiment of a network management system 100 that is configured to implement power budget management for one or more units of power sourcing equipment. The system 100 shown in FIG. 1 can be implemented in a data center or enterprise application. Other embodiments can be implemented in other ways (for example, where the system 100 is implemented in a central office or other facility of a telecommunication service provider and/or in another part of the telecommunication service provider's network).

System 100 includes one or more units of power sourcing equipment (PSE) managed by a network system manager 138. In FIG. 1, an example PSE is shown as power sourcing network switch 120, which is coupled to a network 136. In this exemplary embodiment, the network 136 is implemented as an ETHERNET LAN and, as a result, the power sourcing network switch 120 comprises an ETHERNET interface for communicating with the network 136. In some embodiments, network 136 may be connected to other networks, such as the public Internet for example, by a gateway 135. The power sourcing network switch 120 is further coupled to at least one item of patching equipment 102 (such as patch panels). In some embodiments, the patching equipment 102 is deployed in a rack 118 along with power sourcing network switch 110 or other items of equipment (not shown) (such as servers and routers, for example). In the example shown in FIG. 1, the power sourcing network switch 120 is shown as having four ports 114, and the patching equipment 102 is shown as having four ports 106. However, it is to be understood that this is for the purposes of illustration and that the patching equipment 102 and power sourcing network switch 120 can each include a different number of ports.

As shown in FIG. 1, in this exemplary embodiment, for at least some of the patching equipment 102, fixed cables 142 are connected to the back of the patching equipment 102 (for example, using punch-down blocks). The patching equipment 102 is configured so that each port 106 on the front of the patching equipment 102 is connected to at least one fixed cable 142 on the back of the patching equipment 102 in order to establish a communication path between that port 106 and the at least one fixed cable 142. The other end of each fixed cable 142 is terminated at a network outlet assembly (referred to herein generally as “outlet assembly” 144). For example, the outlet assembly 144 may comprises a wall, ceiling or floor outlet that is deployed in a worked area, a consolidation point (sometimes referred to as a Multi-User Telecommunications Outlet, or MUTOA), or another item of patching equipment. Also, for ease of explanation, only a single fixed cable 142 and outlet assembly 144 is shown in FIG. 1. However, it is to be understood that multiple fixed cables 142 and outlet assemblies 144 (of various types) coupled to other ports 106 of patching equipment 102 can and typically would be used.

Each outlet assembly 144 typically includes one or more ports 146. For example, where the outlet assembly 144 is a wall outlet as shown in FIG. 1, the wall outlet assembly 144 includes one or more ports 146 on the front of the outlet assembly 144 which may be used by a network powered device 188 to connect with network 136 and to received power from the power sourcing network switch 120. That is, the fixed cable 142 may provide for both data connectivity by transporting network data traffic, and the delivery of electric power. In alternate embodiments, fixed cable 142 may comprise separate electrical conductors for carrying data signals versus electric power. In other embodiments, data signals and electric power may be carried over the same electrical conductors of cable 142. In still other embodiments, cable 142 may comprise optical fiber for carrying data traffic, and electrical conductors to deliver electric power.

In example shown in FIG. 1, the outlet assembly 144 is shown as having one port 146. However, it is to be understood that this is for the ease of illustration and that the outlet assembly 144 can include a different number of ports 146. In the example shown in FIG. 1, each outlet assembly 144 can also comprise a faceplate 147 to which the one or more ports 146 are mounted. The outlet assemblies 144 can be implemented in other ways. Where the outlet assembly 144 is a consolidation point, the consolidation point 144 includes multiple ports 146 where respective fixed cables 142 can be terminated at the rear of the ports 146 and other cables can be connected to the front of the ports 146, where each of those other cables can be terminated at its other end in the work area (for example, at a wall outlet). Where the outlet assembly 144 is another item of patching equipment, that other item of patching equipment also includes multiple ports where the relevant fixed cable 142 can be terminated at the rear of one of the ports 146 and other cables can be connected to the front of that port 146.

In some embodiments, the network management system 100 may optionally further constitute, or function as, an automatic infrastructure management (AIM) system configured to track connections made at the patching equipment 102 as well as connections with the other equipment. In such embodiments, the network management system 100 is configured to work with patching equipment 102 that has AIM functionality 104 for tracking connections made at the ports 106 located on the front (or patching) side of the patching equipment 102. In such embodiments, the patching equipment 102 may be referred to here as “intelligent patching equipment” 102. For each port 106 of the associated item of intelligent patching equipment 102, the AIM functionality 104 comprises a sensor, reader, interface, or other circuitry (collectively referred to here as a “sensor”) 108 for use in determining the presence of, and/or information from or about, a connector and/or cable attached to the associated port 106. The AIM functionality 104 can be implemented in many different ways and the particular configuration illustrated in FIG. 1 is merely exemplary and should not be construed as limiting. For example, various types of AIM technology can be used. One type of AIM technology infers connection information by sensing when connectors are inserted or removed from ports. Another type of AIM technology makes use of so-called “ninth wire” or “tenth wire” technology. Ninth wire/tenth wire technology makes use of special cables that include one or more extra conductors or signal paths that are used for determining which port each end of the cable is inserted into. Yet another type of AIM technology makes use of an Electrically Erasable Programmable Read-Only Memory (EEPROM) or other storage device that is integrated with or attached to a connector on a cable. The storage device is used to store an identifier for the cable or connector along with other information. The port (or other connector) into which the associated connector is inserted is configured to read the information stored in the EEPROM when the connector is inserted into the front side of a port of a patch panel or other item of patching equipment. A similar approach can be used with optical machine-readable representations of data (such as barcodes or QR codes). Another type of AIM technology makes use of radio frequency identification (RFID) tags and readers. With RFID technology, an RFID tag is attached to or integrated with a connector on a cable. The RFID tag is used to store an identifier for the cable or connector along with other information. The RFID tag is typically then read using an RFID reader after the associated connector is inserted into a port (or other connector) of a patch panel or other item of patching equipment. Still other types of AIM technology can be used.

Each item of intelligent patching equipment 102 may include a respective programmable processor 114 that is communicatively coupled to the other AIM functionality 104 in that item of patching equipment 102 and configured to execute software that reads or otherwise receives information from each sensor 108. Some embodiments may include a controller 116 configured to be connected to, and manage, patching equipment 102 having AIM functionality 104 that is installed in one or more racks 118 and is also referred here as a “rack controller 116.” Each rack controller 116 aggregates connection information for the ports 106 of the patching equipment 102 in the associated racks 118 and configured to use the sensor 108 associated with each port 106 of the patching equipment 102 mounted in the associated rack 118 to monitor the state of each port 106 and identify connection or disconnection events occurring at that port 106 (for example, by detecting changes in the connection state of the port 106). As shown in FIG. 1, each rack controller 116 provides asset and connection information to the system manager 138. The system manager 138 stores the resulting asset and connection information in cabling information database 140.

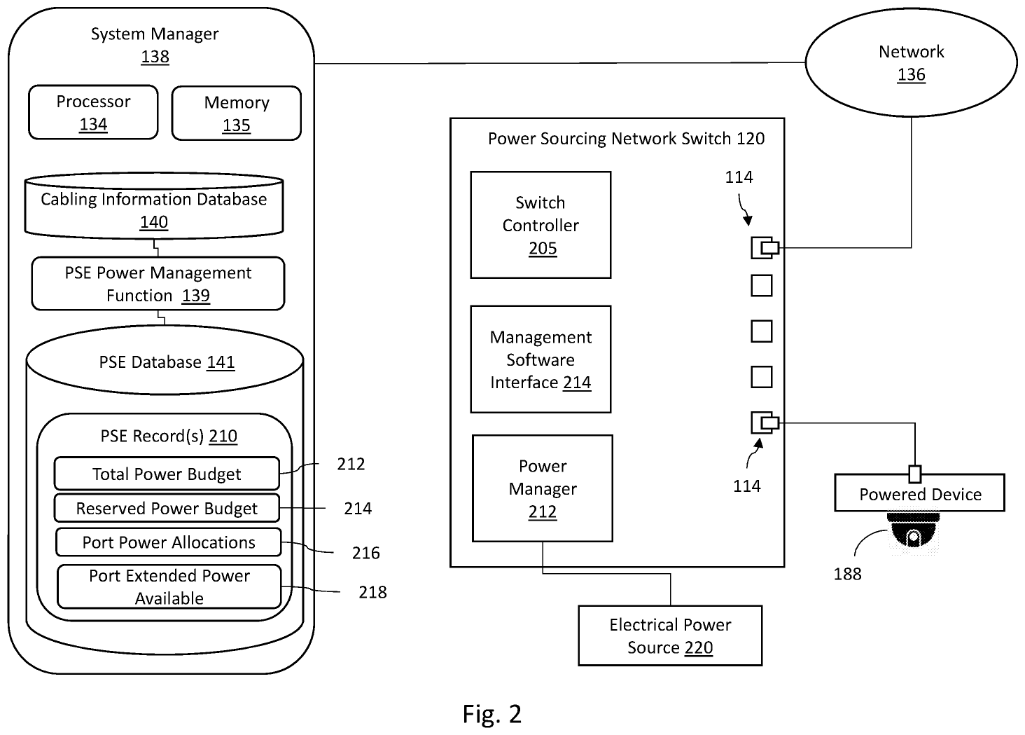

FIG. 2 is a diagram of an example system manager 138 and example power sourcing network switch 120 which may be used in conjunction with the network management system 100 illustrated in FIG. 1, though it is to be understood that other embodiments can be implemented in other ways.

Power sourcing network switch 120 includes a plurality of switch ports 114. The switch ports 114 may be used, for example, for interconnecting the power sourcing network switch 110 with the ports 106 of patching equipment 102 and with network 136. Functions for operating as a network switch, including the switching of packets between the ports 114, may be implemented by a switch controller 205. The switch controller 205 may comprise a processor coupled to a memory comprising code executed by the processor to perform the various functions of the network switch 110 described herein. Power sourcing network switch 120 further comprises a power manager function 212 that controls the application of electric power from an external power source 220 onto the ports 114. In some embodiments, power manager 212, at least in part, controls the controls the application of electric power onto the ports 114 in accordance with one or more industry standards such as, but not limited to the IEEE 802.3 family of standards and/or other Power-over-Ethernet (PoE) standards. The power manager function 212 may be implemented using a combination of electrical circuits and software executed by the switch controller 205. As shown in FIG. 2, the power sourcing network switch 120 further includes a management software interface 214 which may be accessed by the system manager 138 for sending control commands to the controller 205 and power manager 212, and receiving information from the controller 205 and power manager 212. For example, in one embodiment the management software interface 214 provides a Simple Network Management Protocol (SNMP) interface, an HTTP web page portal, or other interface to which commands may be communicated to access and operate management functions of the power sourcing network switch 120 (including allocating power resources to selected ports 114, turning power to selector ports 114 on and off, as well as other functions such as communication link status for any of the ports 114).

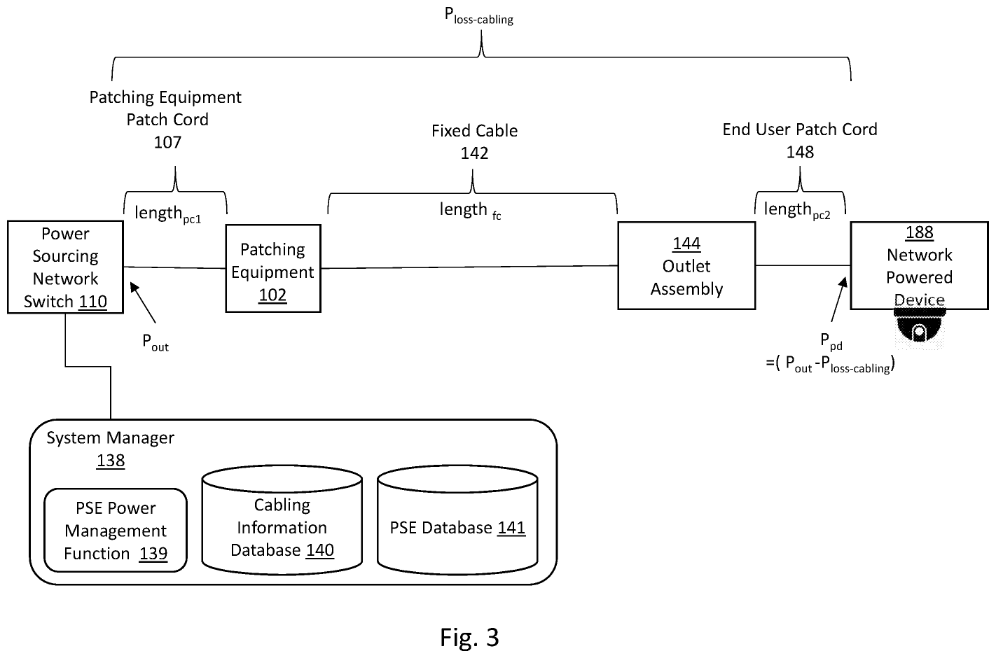

As shown in FIG. 2, the system manger 138 comprises at least one processor 134 coupled to a memory 135, and which may implement one or more of the various functions of the system manager 138 described herein through the execution of code. In some embodiments, the system manger 138 may be implemented by a server or other network node coupled to the network 136. System manager 138 further comprises a PSE power management function 139 (which may be implemented by the processor 134), the cable information database 140, and a PSE database 141. As discussed above, the cable information database 140 includes data regarding the types, lengths, and interconnectivity of cabling in system 100. In particular, the cable information database 140 includes for example, the lengths and interconnectivity of cabling that interconnect the ports of power sourcing network switch 110 with network powered device 188. Referring to FIG. 3, the connection between the power sourcing network switch 110 and the network powered device 188 may include one or more of a patching equipment patch cord 107, a fixed cable 142 and an end user patch cord 148. Fixed cables 142 typically comprise one or more segments of network cabling that are installed in walls, ceiling, cable trays, and so forth, that are essentially permanent features of the facility. Fixed cables 142 are not typically moved or re-routed as part of a routine network reconfiguration. Accordingly, a fixed cable may be considered in contrast to a “patch cord” network cable. Patching connections between switch 120 and patching equipment 102 may be made using patch cords 107 that are connected between the ports 114 and 106. Patching connections between the network powered device 188 and a port 146 of the outlet assembly 144 may similarly be made using patch cords 148. It should be understood that this configuration shown in FIG. 3 is provided for illustrative purposes only. In other embodiments, a power sourcing network switch 110 may be connected directly to an outlet assembly 144, or directly to a network powered device 188. In other embodiments, there may be multiple instances of patching equipment 102 intervening between the power sourcing network switch 110 and the network powered device 188.

Regardless of the specific configuration, the information in the cabling information database 140 may be read by the PSE power management function 139 to determine a length for each item of network cabling (whether fixed cables or patch cords) that is being used to interconnect the power sourcing network switch 110 with the network powered device 188, and based on that information calculate a power loss associated with each item of network cabling and/or a power loss associated with the total length of cabling from the power sourcing network switch 110 to the network powered device 188. The PSE power management function 139 may receive a power allocation request that comes from a user or via the switch 120. In some embodiments, when the PSE power management function 139 receives a request to allocate power from the switch 120 to a network powered device 188, the PSE power management function 139 requests connectivity information and receives from the cable information database 140 the length of each instance of cabling for the path between the switch 120 and the network powered device 188. In some embodiments, the PSE power management function 139 may comprise a tracing functionality that determines from information in the cable information database 140 which items of network cabling comprise the cable path and then retrieves the cable length information from cable information database 140 itself. In other embodiments, the PSE power management function 139 may interface with other cable management functions of the system manager 138 and obtain the cable length information via those other cable management functions. Once the cable length information is retrieved, the PSE power management function 139 may calculate a power loss for the cabling (for example, by using standard power loss calculations know to those skilled in the art, utilizing a table or other cross-reference to correlate a cable length to a power loss, etc.). As one example, in one implementation, the current output (Iₒᵤₜ) drawn from the port 114 of the power sourcing network switch 120 may be calculated as Iₒᵤₜ=Pₒᵤₜ/Vₒᵤₜ where Pₒᵤₜ is the power output supplied at the port 114 and Vₒᵤₜ is the voltage supplied at port 114. The drop in voltage across the length of the network cabling due to cable resistance may then be calculated to determine the actual voltage V_{pd} that would be received at the network powered device 188 given Vₒᵤₜ at the port 114. The actual power available at the network powered device 188 is then obtained as P_{pd}=Iₒᵤₜ×V_{pd}. In some embodiments, the length of the network cabling used to calculate the voltage drop may be determine as sum of the multiple segments of cable. For example, in the implementation shown in FIG. 3, the length of the network cabling used to calculate the voltage drop would comprise the sum of the lengths of patch cord 107, fixed cable 142 and end user patch cord 148. In other embodiments, a power drop calculation may instead be performed as described above for each individual segment of cabling and those results combined to determine the actual power P_{pd} available at the network powered device 188.

In some embodiments, when the PSE power management function 139 receives the request to allocate power from the switch 120 to the network powered device 188, that request will include an indication of the power class of the network powered device 188, which indicates the power requirements the network powered device 188 needs to operate. By determining the power drop caused by the network cabling, PSE power management function 139 can then determine the power from the power sourcing network switch 120 that needs to be allocated to the port 114 in order for the power available at the network powered device 188 to be adequate to satisfy its power class.

In some embodiments, the PSE power management function 139 may be provided additional information from the cable information database 140 that it may use to increase the accuracy of its calculation. For example, the cable information database 140 may include information such as the material type and/or wire gauge of the cable so that the PSE power management function 139 may more accurately determine the resistance of the cable before calculating voltage drop. Alternatively, the cable information database 140 may instead directly indicate the resistance of the cable as provided either from the manufacturer or as determined from field testing or other means. In some embodiments, if an indication of a cable segment's resistance is not available, a default value may be used in the calculation.

As described above, the PSE power management function 139 can accurately determine the Pₒᵤₜ port power output supplied at the port 114 needed to provide an actual power P_{pd} to the network powered device 188 given the actual length and/or other characteristics of the network cabling connecting the two. In some embodiments, the PSE power management function 139 then proceed with sending a power allocation command to the power manager function 212 (for example, via the management software interface 214) to allocate the calculated Pₒᵤₜ port power output to the port 114 and energize the port 114 accordingly.

In some embodiments, the PSE power management function 139 further communicates with the PSE database 141 which maintains information about the available power budgets, capacities, current allocations, and other data regarding the power sourcing network switch 120 and other PSE managed by the PSE power management function 139. For example, in some embodiments, the PSE database 141 may maintain a PSE record 210 associated with the power sourcing network switch 120 that may include data such as, but not limited to, a total power budget 210, a reserved power budget 212, port power allocations 216, and/or port power extension available 218. For example, the total power budget 210 indicates the total power sourcing capacity of the power sourcing network switch 120, while the reserved power budget 212 indicates how much of the total power sourcing capacity has already been allocated to ports 115 of the switch 212. For example, the PSE power management function 139 may determine from the total power budget 210 that the power sourcing network switch 120 has a total capacity of 100 watts and from the reserved power budget 212 that 80 watts of the 100 watts have already been allocated amongst the ports 114 of the switch 120. As such, if a request to power an additional powered device is received that will require a Pₒᵤₜ port power output from the switch of 15 watts, the PSE power management function 139 will proceed to send the power allocation command to the power manager function 212 to allocate the Pₒᵤₜ port power level to the additional powered device, and update the reserved power budget 212 accordingly (to now indicate that 95 watts of the 100 watts have already been allocated amongst the ports 114 of the switch 120). In contrast, if the PSE power management function 139 finds from the reserved power budget 212 that there is not a sufficient unallocated budget remaining from the total power budget 210 to provide the Pₒᵤₜ port power level, it may notify the switch 120 that the request to allocate power to the additional powered device is denied. In some embodiments, the PSE database 141 may also record in the port power allocations 216 how much power has been allocated to each port 114 of the switch 120. The port power allocations 216 may be recorded instead of, or in addition to, the reserved power budget 212. For example, the PSE power management function 139 may determine how much of the total power budget 210 has already been allocated by summing the allocations for each individual port 114 as recorded in the port power allocations 216.

In some embodiments, PSE power management function 139 may instead use cabling length information from the cabling information database 140 to determine when requests for extended power may be accepted, and determine an extended power budget indicating how much extended power may be granted to a port 114 of the power sourcing network switch 120. For example, in some embodiments, a network powered device 188 may initially be allocated power based on an initial power level (as described in this disclosure above), and subsequently indicate the need for additional power beyond what it was initially allocated. For example, under legacy worst-case cable length assumptions (e.g., 100 meters), given a network powered device 188 requiring P_{pd} available at the network powered device 188, the switch 120 port 114 powering that device might be allocated a default P_{default} port power output level that is more than necessary to adequately supply the network powered device 188. In some embodiments, the PSE power management function 139 described herein utilizes cable length information to determine a power loss due to the network cabling, P_{loss-cabling}, and from that calculates the Pₒᵤₜ port power output from the port switch actually needed to deliver P_{pd} to the network powered device 188. As such, the power device 188 may actually be allowed to consume extended power above the P_{pd} power originally allocated to the degree that the actual network cabling length is less than the worst-case cable length assumptions. More specifically, the potential extended power available to a network powered device 188 over its initial allocation may be calculated as P_{extended}=P_{default}−P_{pd}−P_{loss-cabling}. In some embodiments, this extended power potentially available for each port 114 is calculated per each port 114 and stored in the port extended power available 218. As such, in some embodiments, when the PSE power management function 139 receives a request for extended power for a port 114, the port extended power available 218 will indicate how much extended power may be allocated to that port 114. For example, in one embodiment, a network powered device 188 may comprise a lighting device that is initially set to energize at a first brightness level, and which is initially allocated power to its port 114 based on that power consumption. If the network powered device 188 is subsequently adjusted to a higher brightness level, and requests a corresponding increase in allocated power to meet that increased demand, the PSE power management function 139 may refer to the port extended power available 218 to determine if the request for extended power can be granted. Similarly, in another example embodiment, the network powered device 188 may be configured to connect to additional network powered devices and pass power to those additional devices (such as in a daisy chain fashion, for example). As such, when an additional network powered device is connected to the original network powered device 188, the network powered device 188 may requests a corresponding increase in allocated power to meet the increased power needs. The PSE power management function 139 may similarly refer to the port extended power available 218 to determine if the request for extended power can be granted. When request for extended power are available, the PSE power management function 139 may proceed to send power allocation to the power manager function 212 to increase the Pₒᵤₜ port power output allocation for the port 114 accordingly. In such cases, the PSE power management function 139 may update the reserved power budget 212, port power allocations 216, and/or port power extension available 218 information to reflect that allocation of addition power to the corresponding port 114.

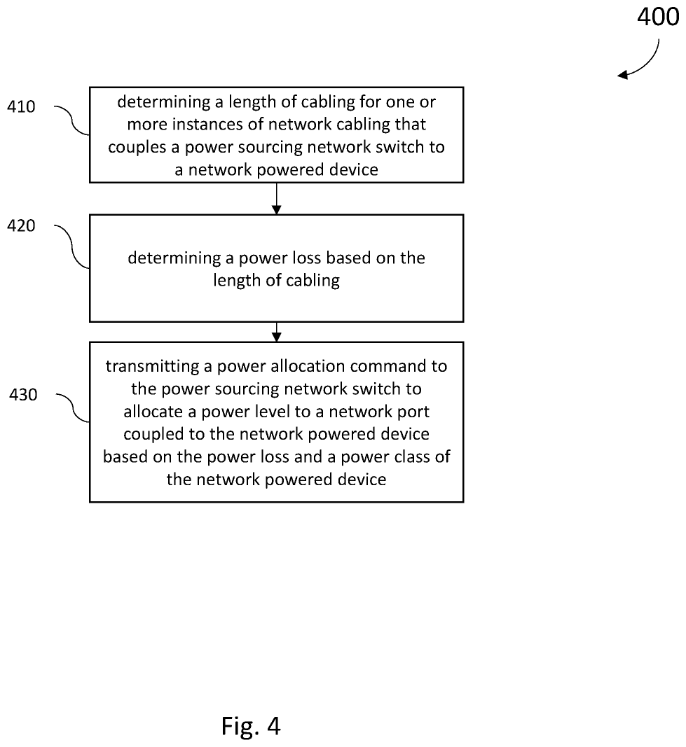

FIG. 4 is flow chart illustrating an example embodiment of a method for power sourcing equipment power allocation. It should be understood that the features and elements described herein with respect to the method 400 shown in FIG. 4 and the accompanying description may be used in conjunction with, in combination with, or substituted for elements of any of the other embodiments discussed with respect to FIGS. 1-3, or elsewhere herein, and vice versa. Further, it should be understood that the functions, structures and other description of elements associated with embodiments of Figure may apply to like named or described elements for any of the other figures and embodiments and vice versa.

The method begins at 410 with determining a length of cabling for one or more instances of network cabling that couples a power sourcing network switch to a network powered device. In some embodiments, determining the length of cabling may be based on network cable length information stored in a cabling information database. In some embodiments, a PSE power management function is configured to access information stored in the cabling information database to determine the length of cabling. In other embodiments, the PSE power management function is configured to obtain the length of cabling from a cable management function of the system manager. The one or more instances of network cabling that couples the power sourcing network switch to the network powered device may comprise one or more individual cable segments.

The method proceeds to 420 with determining a power loss based on the length of cabling. In some embodiments, other factors such as the material type and wire gauge of the network cabling may be included in determining the power loss of the network cabling. The method proceeds to 430 with transmitting a power allocation command to the power sourcing network switch to allocate a power level to a network port coupled to the network powered device based on the power loss and a power class of the network powered device. In some embodiments, the power allocation command is transmitted to the power sourcing network switch from a (PSE) power management function implemented on a system manager coupled to the power sourcing network switch through a network. In some embodiments, the method may further comprise determining if the power sourcing network switch can support allocating the power level to the network port based on a PSE database that includes a PSE record associated with the power sourcing network switch. In such an embodiment, the power allocation command is transmitted when that determination confirms that the power sourcing network switch can support allocating the power level. In some embodiments, the method may optionally further include calculating an extended power budget available to the network powered device as a function of the power loss due to the length of cabling. In such an embodiment, the method may further include transmitting an extended power allocation command to the power sourcing network switch when the request is within the extended power budget.

### EXAMPLE EMBODIMENTS

Example 1 includes a system manager for a network management system, the system manager comprising: a processor coupled to a memory; a power sourcing equipment (PSE) power management function implemented by the processor; and a cabling information database; wherein the PSE power management function is configured to communicatively couple to a power sourcing network switch via a network; wherein the PSE power management function, in response to receiving a request to allocate power from the power sourcing network switch to a network powered device: determines a length of cabling for one or more instances of network cabling that couples the power sourcing network switch to the network powered device based on network cable length information stored in the cabling information database; determines a power loss based on the length of cabling; and transmits a power allocation command to the power sourcing network switch to allocate a power level to a network port coupled to the network powered device based on the power loss and a power class of the network powered device.

Example 2 includes the system manager of example 1, wherein the power class of the network powered device is communicated to the PSE power management function in the request.

Example 3 includes the system manager of any of examples 1-2, wherein the PSE power management function is configured to access information stored in the cabling information database to determine the length of cabling.

Example 4 includes the system manager of any of examples 1-3, wherein the PSE power management function is configured to obtain the length of cabling from a cable management function of the system manager.

Example 5 includes the system manager of any of examples 1-4, wherein the PSE power management function communicates with the power sourcing network switch through a management software interface of the power sourcing network switch.

Example 6 includes the system manager of any of examples 1-5, wherein the one or more instances of network cabling that couples the power sourcing network switch to the network powered device comprises a plurality of cable segments.

Example 7 includes the system manager of any of examples 1-6, wherein the PSE power management function further obtains one or both of a material type and a wire gauge for the one or more instances of network cabling from the cabling information database and determines the power loss based on the length of cabling and further based on the material type, the wire gauge, or both.

Example 8 includes the system manager of any of examples 1-7, further comprising: a PSE database that includes a PSE record associated with the power sourcing network switch, wherein the PSE power management function determines if the power sourcing network switch can support allocating the power level to the network port based on the PSE record.

Example 9 includes the system manager of example 8, wherein the PSE record associated with the power sourcing network switch includes one or more of: an indication of a total power budget for the power sourcing network switch; and an indication of how much of the total power budget has been allocated.

Example 10 includes the system manager of any of examples 8-9, wherein the PSE power management function updates the PSE record based on the power level allocated to the network port.

Example 11 includes the system manager of any of examples 1-10, wherein the PSE power management function is configured to calculate an extended power budget available to the network powered device as a function of the power loss due to the length of cabling; and in response to a request for an additional power allocation, the PSE power management function transmits an extended power allocation command to the power sourcing network switch based on the extended power budget.

Example 12 includes a method for power sourcing equipment power allocation, the method comprising: determining a length of cabling for one or more instances of network cabling that couples a power sourcing network switch to a network powered device; determining a power loss based on the length of cabling; and transmitting a power allocation command to the power sourcing network switch to allocate a power level to a network port coupled to the network powered device based on the power loss and a power class of the network powered device.

Example 13 includes the method of example 12, wherein determining a length of cabling for one or more instances of network cabling is based on network cable length information stored in a cabling information database.

Example 14 includes the method of example 13, wherein determining the power loss comprises: calculating the power loss based on the length of cabling and further based on a material type of the one or more instances of network cabling, a wire gauge of the one or more instances of network cabling, or both.

Example 15 includes the method of any of examples 12-14, wherein the power allocation command is transmitted to the power sourcing network switch from a power sourcing equipment (PSE) power management function implemented on a system manager coupled to the power sourcing network switch through a network.

Example 16 includes the method of example 15, wherein the power class of the network powered device in communicated to the PSE power management function in the request.

Example 17 includes the method of any of examples 15-16, wherein the PSE power management function is configured to access information stored in a cabling information database to determine the length of cabling.

Example 18 includes the method of any of examples 15-17, wherein the PSE power management function is configured to obtain the length of cabling from a cable management function of the system manager.

Example 19 includes the method of any of examples 12-18, wherein the one or more instances of network cabling that couples the power sourcing network switch to the network powered device comprises a plurality of cable segments.

Example 20 includes the method of any of examples 12-19, further comprising: determining if the power sourcing network switch can support allocating the power level to the network port based on a PSE database that includes a PSE record associated with the power sourcing network switch.

Example 21 includes the method of example 20, wherein the PSE record associated with the power sourcing network switch includes one or more of: an indication of a total power budget for the power sourcing network switch; and an indication of how much of the total power budget has been allocated.

Example 22 includes the method of any of examples 12-21, further comprising: calculating an extended power budget available to the network powered device as a function of the power loss due to the length of cabling.

Example 23 includes the method of example 22, further comprising: in response to a request for an additional power allocation, transmitting an extended power allocation command to the power sourcing network switch based on the extended power budget.

In various alternative embodiments, system and/or device elements, method steps, or example implementations described throughout this disclosure (such as any of the system managers, servers, gateway, network, rack, controllers, processors, patching equipment, power sourcing network switch, outlets, network powered devices, databases, PSE power management function, power manager, management software interface, or sub-parts of any thereof, for example) may be implemented at least in part using one or more computer systems, field programmable gate arrays (FPGAs), or similar devices comprising a processor coupled to a memory and executing code to realize those elements, steps, processes, or examples, said code stored on a non-transient hardware data storage device. Therefore, other embodiments of the present disclosure may include elements comprising program instructions resident on computer readable media which when implemented by such computer systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to, computer-executable instructions executed by computer system processors and hardware description languages such as Very High-Speed Integrated Circuit (VHSIC) Hardware Description Language (VHDL).

As used herein, terms such as “system manager”, “server”, “gateway”, “network”, “rack”, “controllers”, “processors”, “patching equipment”, “power sourcing network switch”, “outlets”, “network powered devices”, “database”, “management software interface”, each refer to non-generic elements of a wireless communication system that would be recognized and understood by those of skill in the art and are not used herein as nonce words or nonce terms for the purpose of invoking 35 USC 112(f).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

1. A system manager for a network management system, the system manager comprising:
a processor coupled to a memory;
a power management function implemented by the processor; and
a cabling information database;
wherein the power management function is configured to communicatively couple to a power sourcing network switch via a network;
wherein the power management function, in response to receiving a request to allocate power from the power sourcing network switch to a network powered device:
determines a length of cabling for one or more instances of network cabling that couples the power sourcing network switch to the network powered device based on network cable length information stored in the cabling information database;
determines a power loss based on the length of cabling; and
transmits a power allocation command to the power sourcing network switch to allocate a power level to a network port coupled to the network powered device based on the power loss and a power class of the network powered device.

2. The system manager of claim 1, wherein the power class of the network powered device is communicated to the power management function in the request.

3. The system manager of claim 1, wherein the power management function is configured to access information stored in the cabling information database to determine the length of cabling.

4. The system manager of claim 1, wherein the power management function is configured to obtain the length of cabling from a cable management function of the system manager.

5. The system manager of claim 1, wherein the power management function communicates with the power sourcing network switch through a management software interface of the power sourcing network switch.

6. The system manager of claim 1, wherein the one or more instances of network cabling that couples the power sourcing network switch to the network powered device comprises a plurality of cable segments.

7. The system manager of claim 1, wherein the power management function further obtains one or both of a material type and a wire gauge for the one or more instances of network cabling from the cabling information database, and determines the power loss based on the length of cabling and further based on the material type, the wire gauge, or both.

8. The system manager of claim 1, further comprising:
a database that includes a record associated with the power sourcing network switch, wherein the power management function determines if the power sourcing network switch can support allocating the power level to the network port based on the record.

9. The system manager of claim 8, wherein the record associated with the power sourcing network switch includes one or more of:
an indication of a total power budget for the power sourcing network switch; and
an indication of how much of the total power budget has been allocated.

10. The system manager of claim 8, wherein the power management function updates the record based on the power level allocated to the network port.

11. The system manager of claim 1, wherein the power management function is configured to calculate an extended power budget available to the network powered device as a function of the power loss due to the length of cabling; and
in response to a request for an additional power allocation, the power management function transmits an extended power allocation command to the power sourcing network switch based on the extended power budget.

12. A method for power sourcing equipment power allocation, the method comprising:
determining a length of cabling for one or more instances of network cabling that couples a power sourcing network switch to a network powered device;
determining a power loss based on the length of cabling; and
transmitting a power allocation command to the power sourcing network switch to allocate a power level to a network port coupled to the network powered device based on the power loss and a power class of the network powered device.

13. The method of claim 12, wherein determining a length of cabling for one or more instances of network cabling is based on network cable length information stored in a cabling information database.

14. The method of claim 13, wherein determining the power loss comprises:
calculating the power loss based on the length of cabling and further based on a material type of the one or more instances of network cabling, a wire gauge of the one or more instances of network cabling, or both.

15. The method of claim 12, wherein the power allocation command is transmitted to the power sourcing network switch from a power management function implemented on a system manager coupled to the power sourcing network switch through a network.

16. The method of claim 15, wherein the power class of the network powered device in communicated to the power management function in a request.

17. The method of claim 15, wherein the power management function is configured to access information stored in a cabling information database to determine the length of cabling.

18. The method of claim 15, wherein the power management function is configured to obtain the length of cabling from a cable management function of the system manager.

19. The method of claim 12, wherein the one or more instances of network cabling that couples the power sourcing network switch to the network powered device comprises a plurality of cable segments.

20. The method of claim 12, further comprising:
determining if the power sourcing network switch can support allocating the power level to the network port based on a database that includes a record associated with the power sourcing network switch.

21. The method of claim 20, wherein the record associated with the power sourcing network switch includes one or more of:
an indication of a total power budget for the power sourcing network switch; and
an indication of how much of the total power budget has been allocated.

22. The method of claim 12, further comprising:
calculating an extended power budget available to the network powered device as a function of the power loss due to the length of cabling.

23. The method of claim 22, further comprising:
in response to a request for an additional power allocation, transmitting an extended power allocation command to the power sourcing network switch based on the extended power budget.
